(19) United States
(12) Patent Application Publication
(10) Pub. No.: US 2005/0140501 A1
(43) Pub. Date: Jun. 30, 2005

(54) Memory for RFID tags that is suitable for receiving a deactivation command

(75) Inventors: Pierre Rizzo, Aix-en-Provence (FR); Christophe Moreaux, Simiane (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 11/006,483

(22) Filed: Dec. 6, 2004

(30) Foreign Application Priority Data
Dec. 16, 2003 (FR) 03 14743

(51) Int. Cl. H04Q 5/22

(52) U.S. Cl. 340/10.51; 711/103; 340/10.5

(57) ABSTRACT

A memory for a contactless tag of the RFID type is configured to receive a deactivation command. The memory includes a group of memory words that are suitable for storing an identifier of the tag and are write-accessible via a standard write command. The memory further includes at least one additional memory word suitable for storing a deactivation value. The detected presence of the deactivation value makes it possible for the tag to prevent reading and/or the transmission of the identifier in response to a radio interrogation signal.

### PRIORITY CLAIM

This application claims priority from French Application for Patent No. 03 14743 filed Dec. 16, 2003, the disclosure of which is hereby incorporated by reference.

### BACKGROUND OF THE INVENTION

1. Technical Field of the Invention

The present invention relates in a general manner to memories for Radio Frequency IDentification (RFID) tags used especially to allow products to be traced. More particularly, it relates to such a memory suitable for receiving a deactivation command.

2. Description of Related Art

A new generation of tags of very small sizes (side of the order of 1000 μm) allows the tracing not only of a range of products, but of each product individually. An exemplary RFID tag is presented in FIG. 1. Having no energy source of its own, it comprises an antenna 2 and an electronic circuit 3 including a memory in which is stored each product's own identifier. An RFID tag includes a transmitter/receiver whose power is fed remotely from a radio field 10 of a remote interrogation unit 4. It transmits the identifier stored in response to an interrogation message contained in a radio signal 20 received from the interrogation unit 4.

The memory serving to code the identifier may be a memory of, for example, 64 bits of the One Time Programmable (OTP) type or of the Electrically Erasable Programmable Read Only Memory (EEPROM) type.

Such a memory is typically organized into memory words, the whole set of such words forming the memory plane. A memory word consists of a certain number of adjacent memory cells, each storing one bit, and placed on one and the same row of the memory plane. A memory word typically comprises 8 cells, the content of which (i.e., a byte) is called a binary word. As a general rule, one byte at a time is written and/or read by addressing the corresponding memory word. It is also possible to read or write several memory words at once, in an access mode called page mode.

Under pressure from consumer organizations, a need exists to be able to reset a tag or at the very least to render it anonymous, when the need to trace the product no longer exists. Various possibilities exist for rendering the tag unable to communicate, and hence totally undetectable by an interrogation radio signal.

One can envisage breaking the tag, in particular by mechanical destruction, but this implies direct contact with the tag. It can also be destroyed electrically, for example by applying a voltage high enough to blow a fuse in the tag, this operation nevertheless requiring energy that is difficult to transfer without contact.

Another possibility consists in altering the information contained in the memory. Specifically, current work by the “Auto ID” laboratory, encompassing several universities and enterprises from the electronics sector, is geared towards a command making it possible to write a certain value into the memory of the tag, which value renders the tag definitively unable to communicate. An article describing this research was published by EETIMES (see web link http://www.eetimes.com/story/OEG20030428S0074) the disclosure of which is hereby incorporated by reference.

Thus, it is for example possible to envisage setting all the bits of the memory of the tag to a zero value. The memory is then reinitialized. It may therefore be overwritten. The tag certainly becomes anonymous but remains no less active (i.e., operational). In particular, it can continue to transmit a response to an interrogation signal, thereby rendering its presence detectable.

Furthermore, it may be useful not to erase the identifier of the tag, so as to facilitate for example the diagnosis of a problem when, for one reason or another, a tag is no longer responding although it has not deliberately been deactivated.

A need accordingly exists for an RFID tag memory that is capable of being deactivated definitively pursuant to a deactivation command, and hence of being rendered undetectable, without however modifying the content of the memory containing the stored identifier.

### SUMMARY OF THE INVENTION

In accordance with an embodiment of the invention, an integrated circuit memory, for contactless tag of RFID type, comprises a group of memory words that are suitable for storing an identifier of the tag and are write-accessible via a standard write command. At least one additional memory word is included that is suitable for storing a deactivation value making it possible to prevent the reading and/or the transmission of the identifier in response to a radio interrogation signal transmitted by a remote interrogation unit.

The additional memory word may advantageously be write-accessible only via a specific write command, which is different from the standard write command. Thus, the writing of the deactivation value cannot be confused with the writing of the identifier of the tag.

Preferably, the memory comprises a management module suitable for verifying the value stored in the additional memory word, as soon as the tag is sufficiently power fed by a remote interrogation unit, and for placing the tag in a deactivated state when the value is equal to the deactivation value.

Alternatively, the management module is suitable for verifying the value stored in the additional memory word in response to the receipt of an interrogation message, and for preventing the reading and/or the transmission of the identifier when the said value is equal to the deactivation value.

In accordance with an embodiment of the invention, a process is presented for definitively deactivating a contactless tag of RFID type. The tag includes an integrated circuit memory having a group of memory words that are suitable for storing an identifier of the tag and are write-accessible via a standard write command. The process includes writing a deactivation value to an additional memory word different from the group of memory words. The deactivation value stored in the additional memory word is suitable for preventing the reading of the identifier in response to a radio interrogation signal transmitted by a remote interrogation unit.

### BRIEF DESCRIPTION OF THE DRAWINGS

Other characteristics and advantages of the invention will become further apparent on reading the description which follows. The latter is purely illustrative and should be read in conjunction with the appended drawings, in which:

FIG. 1 (previously described) is a diagram illustrating the principle of power feeding a tag;

FIG. 2 is a diagram of an exemplary embodiment of a memory according to the invention;

FIG. 3 is a diagram of an exemplary embodiment of an RFID tag comprising the memory according to the invention;

FIG. 4 is a chart of steps of a first mode of operation of a module for management of the memory according to the invention; and

FIG. 5 is a chart of steps of a second mode of operation of the module for management of the memory according to the invention.

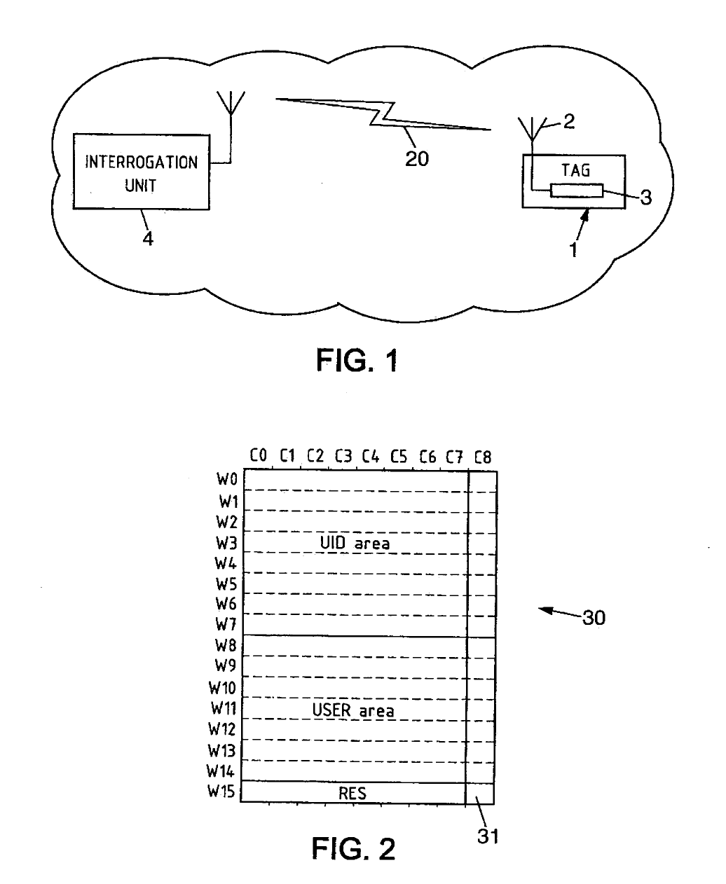

### DETAILED DESCRIPTION OF THE DRAWINGS

A memory may be organized into several memory areas. A first area is reserved for storing the identifier of the tag, and it is called the User IDentification (UID) area. One or more other memory areas may be present also, and are then available for another use to be defined by the user. Such other memory areas are each called a USER area.

An exemplary embodiment of a memory according to an embodiment of the invention is represented in FIG. 2. The memory 30 contains 128 bits, distributed over two areas of identical size. On the one hand, a UID area of 64 bits (for example, 8 memory words W0 to W7 of 8 bits each), is reserved for storing the identifier of the RFID tag. On the other hand, a USER area (for example, comprising 8 memory words W8 to W15, of 8 bits each), is intended for storing supplementary information. The memory therefore, for example, comprises a total of 16 memory words of 8 bits each.

The 8 bits of the 16 memory words are also organized into 8 columns C0 to C7. An additional column C8 is used to store a determined bit, the so-called lockbit, according to the specifications of ISO standard 15693. A lockbit is associated with each memory word. Thus each memory word is write-lockable, by virtue of the lockbit of column C8. Before each command to write a binary word, the content of the lockbit associated with the memory word addressed is verified, and if it is already at a value 1 (the so-called programmed state), the write command is abandoned. If it is at the value 0, the binary word is recorded, and the lockbit is programmed to the value 1. Whereas the memory can be read repeatedly, on the other hand it can be written to only once, and is known as a Write Once Read Many (WORM) memory, or a One Time Programmable (OTP) memory.

In order to carry out the deactivation command capable of deactivating the memory according to an embodiment of the invention, a specific memory word RES is reserved in the USER area (memory words W8 to W15), for example the last word W15 in the example of FIGURE. It is intended for receiving a particular binary word corresponding to a determined value, the so-called deactivation value KILL. Thus, in practice, only the memory words W8 to W14 are available to store user information.

A tag is considered to be in the deactivated state if the content of the memory word RES is equal to the value KILL.

The commands regarding the memory words are also standard. They are of the type:
<OP Code, address, data>
   where:
“OP Code” designates a command code (“OPeration Code”),
“address” is the address of the memory word in the memory 30, and
“data” is the data item to be written to the memory word.
   It will be noted that the “data” field is present only if the command code corresponds to a write operation.

Writing to the ID area and to the USER area is done on the basis of the standard write command corresponding for example to the command code “21” in the ISO standard 15693.

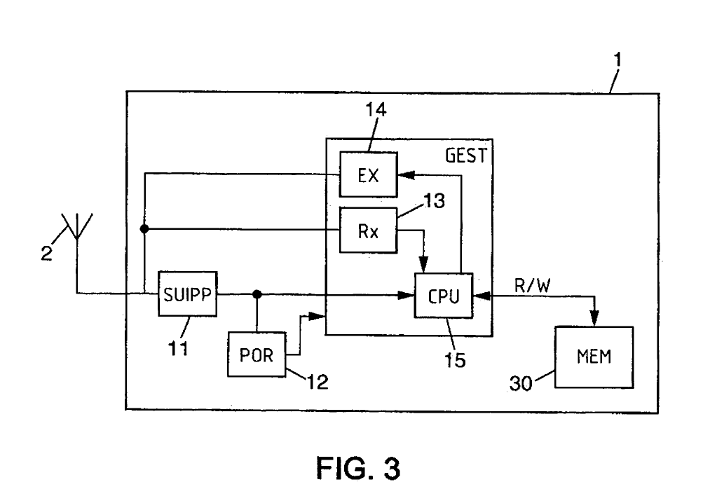

FIG. 3 shows an exemplary electronic circuit contained in the RFID tag. The circuit 3 is coupled to the antenna 2 for the reception of the radio signal 20 originating from the interrogation unit. A supply module 11 is intended for the extraction of the DC supply voltage of the circuit from the radio signal. A reset device 12, or POR device (standing for “Power on Reset”) makes it possible to maintain the electronic circuit in the inactive state (not powered) as long as the supply voltage has not reached a threshold level sufficient to ensure the entirety of the functions of the electronic circuit. A reception module 13 is in charge of extracting an interrogation message or any other command from the radio signal when the interrogation unit transmits such a command. A transmission module 14 is in charge on the other hand of transmitting a response message of the tag to an interrogation message. A processor or more simply a control circuit 15, in the form of hard-wired logic, fulfils the function of central processing unit CPU of the tag and manages in particular the memory 30 in write and read mode. The modules 13 and 14 together with the circuit 15 form a management module GEST.

In a general manner, the management module GEST manages the write/read operations in the memory 30 of the tag 1. In particular it manages the writing of the identifier to the UID area or of other information to the USER area by means of the standard command WRITE_NORM. It then locks the memory word or words concerned by programming the corresponding lockbit to the value 1. It also manages the writing, by means of the specific command WRITE_KILL, of the deactivation value to the specific memory word RES when the radio signal includes the deactivation command. Just as for the standard write command, it also ensures the locking of the memory word RES once the deactivation value has been written to this memory word. To summarize, in response to a write command, standard or specific, the management module performs the writing followed by the locking of the memory word addressed once the write has terminated, without subsequent possibility of erasure or of overwriting. The module GEST also manages the read commands and in particular the command for reading the identifier stored in the UID area, which is the subject of an interrogation message.

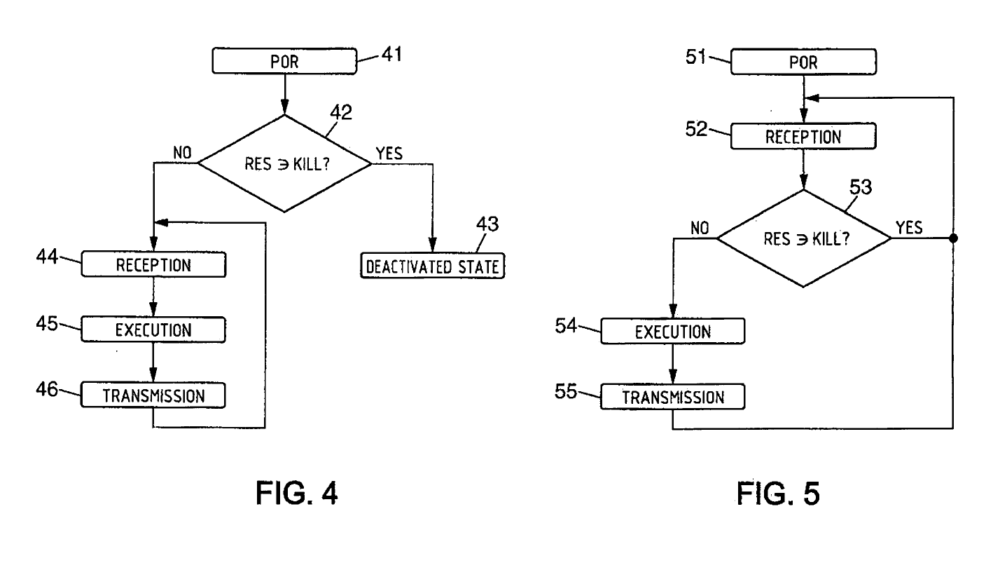

One of the functions of the module GEST is, according to the invention, to ensure the verification of the state of the specific memory RES, for example according to one or other of the algorithms illustrated by the step charts of FIGS. 4 and 5, respectively. In reality this entails ascertaining, at various steps of the operation of the RFID tag, whether or not it is in the deactivated state.

FIG. 4 illustrates a first possible mode of implementation of the algorithm deployed by the management module GEST in particular for the processing of a message interrogating the identifier of the tag. The tag, during its progressive entry into the radio field of the interrogation unit, must firstly be sufficiently energized by tele-energization before the execution of any operation is authorized. Supervision 41 of this condition is carried out by the POR device of FIG. 3, disposed upstream of the electronic circuit 3 of the tag. Such a device is active as long as the power fed to the tag is not sufficient to ensure the operation of all of the components of the tag.

In a step 42, implemented for example as soon as the POR device becomes inactive, that is to say once the supply voltage level is sufficient, but before the actual enabling of the electronic circuit of the tag, the module GEST reads the content of the specific memory word RES. If the memory word RES contains the deactivation value KILL, then the circuit is in force. This command is called WRITE_NORM in the subsequent account. In accordance with the standard, there are however other write commands, of the type “Ai”, which are reserved for the manufacturer.

In one embodiment of the invention, the memory words W0 to W7 of the UID area, as well as the memory words W8 to W14 of the USER area, are programmable via the standard write command WRITE_NORM.

It is possible to envisage programming the specific memory word RES via this same standard write command WRITE_NORM. However, it is preferable to render the memory word RES addressable only via a particular write command WRITE_KILL, distinct from the standard write command WRITE_NORM. The use of the standard command WRITE_NORM as regards to the specific memory word is then without effect.

This addressing of the reserved memory word RES only via the specific command WRITE_KILL makes it possible to avoid any deactivation of the tag by mistake.

For example, the standard command WRITE_NORM “21, OF, 00” remains inoperative, while the specific command WRITE_KILL “A1, OF, 00” makes it possible to implement the deactivation of the tag, where “A1” is, for example, the command code of the specific command WRITE_KILL in accordance with an implementation of the ISO standard 15693 (“Ai” for the manufacturer commands as seen above), and where 00 is for example the deactivation value KILL. Just as for the standard write command WRITE_NORM, the lockbit 31 attached to the memory word RES of FIG. 2 is programmed to the locked value 1 once the WRITE_KILL command has been executed. The memory word RES therefore becomes write-locked. not enabled, and the tag is placed in a deactivated state 43 (i.e., a state in which it cannot respond to the interrogation message). The tag is then undetectable. If the content of the specific memory RES is not the deactivation value KILL, then the management module GEST can execute in a normal way the sequence of steps designed for an interrogation of the tag, namely reception 44 of the interrogation message, followed by execution 45 of the command for reading from the UID area, and finally transmission 46 of the identifier. This sequence may be repeated several times as a function of the command carried by the radio signal.

FIG. 5 illustrates a second possible mode of implementation of the algorithm deployed in the management module GEST. In this variant, the content of the specific memory RES is verified before the execution of each command. After its entry into the radio field and once it is sufficiently energized (i.e. once the POR device determines, in a step 51, that the supply voltage has reached a sufficient level for the POR device to be deactivated), the tag can receive an interrogation message (step 52). In response, the module GEST reads the value stored in the specific memory word RES and compares it with the deactivation value KILL in a step 53. If the memory word RES contains the deactivation value KILL, then the received command is not executed. In particular, the tag does not respond to an interrogation message contained in the radio signal. Provision may also be made for the command to be executed but, when dealing with an interrogation command, that the identifier of the tag is not to be transmitted in response. The tag is therefore undetectable. If the content of the specific memory RES is not the deactivation value, then the management module GEST executes in a normal manner the sequence of steps provided, namely the execution 54 of the command received, and finally the transmission 55 of the identifier when dealing with an interrogation command for example. This sequence may be repeated several times as a function of the command carried by the radio signal.

In another embodiment of the invention, it is possible to deploy an additional security feature by virtue of which the command WRITE-KILL is executable only after the presentation of a password transmitted by the remote interrogation unit or after mutual authentication with the remote interrogation unit, doing so in order to avoid any unauthorized use of this command.

It is actually possible to envisage for example the management module GEST not being able to execute the command WRITE_KILL until after the receipt of a password PSW transmitted by the remote interrogation unit. Thus, the writing by means of the specific command WRITE_KILL of the deactivation value remains inoperative as long as it has not been preceded by the receipt of a radio signal containing a password PSW recognizable by the tag and that makes it possible to unlock the command WRITE_KILL. Thus, the tag is suitable for recognizing a remote interrogation unit which is authorized to deactivate it. The operation of deactivating the tag by the WRITE_KILL command can then follow the route described previously.

It is also possible to envisage mutual authentication between the remote interrogation unit and the tag, which allows the tag to recognize a remote interrogation unit authorized to deactivate it. Once mutual authentication has been carried out, by any known method, the operation of deactivation through the WRITE_KILL command can follow the route described previously.

Due for example to a defect or an error, a tag may have been placed in the deactivated state without the execution of a deactivation command WRITE_KILL (for example, the deactivation value may have been written in error to the specific memory word W15). This is why provision may then be made for a reactivation command making it possible to reactivate the tag so as to analyze the causes of the deactivation. This command makes it possible to reactivate the tag, at least for the time of a power-up, so as to allow the verification of the content of the various memory areas (UID and USER) of a memory according to the invention. Protection may be provided through a password of this reactivation command so as to limit the use thereof to authorized persons only (in particular the manufacturer).

In an advantageous embodiment, provision is furthermore made for the possibility of writing with the specific command WRITE_KILL an item other than the binary word KILL, to the specific memory word RES. This makes it possible to definitively prevent the use of the deactivation command. Specifically, as the lockbit is programmed to the value 1 after the writing of the specific memory, it is then no longer possible to write the deactivation value to the memory word RES. Stated otherwise, the tag can no longer be deactivated.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. An integrated circuit memory, for use in a contactless tag of RFID type, comprising:
a group of memory words that are suitable for storing an identifier of the tag and are write-accessible via a standard write command;
at least one additional memory word suitable for storing a deactivation value; and
a control circuit responsive to presence of the stored deactivation value for preventing the reading and/or the transmission of the identifier in response to receipt of a radio interrogation signal.

2. The memory according to claim 1, wherein the additional memory word is write-accessible only via a specific write command, different from the standard write command.

3. The memory according to claim 1, wherein the control circuit comprises a management module operable to verify the value stored in the additional memory word, as soon as the tag is sufficiently power fed by the remote interrogation unit, and place the tag in a deactivated state when said value is equal to the deactivation value.

4. The memory according to claim 1, wherein the control circuit comprises a management module operable to verify the value stored in the additional memory word in response to the receipt of an interrogation message, and prevent the reading and/or the transmission of the identifier when said value is equal to the deactivation value.

5. The memory according to claim 2, wherein the control circuit is operable to command writing to the additional memory word in response to the specific write command, without possibility of subsequent erasure or overwriting.

6. The memory according to claim 5, wherein the specific write command is executed by the control circuit only after one of either receipt by the tag of a remotely transmitted password or a mutual authentication operation.

7. A method for definitively deactivating a contactless tag of RFID type, wherein the tag includes an integrated circuit memory having a group of memory words that are suitable for storing an identifier of the tag and are write-accessible via a standard write command, the method comprising:
writing a deactivation value to an additional memory word different from said group of memory words;
detecting presence of the deactivation value in said additional memory word; and
preventing the reading and/or the transmission of said identifier in response to a radio interrogation signal if deactivation value presence is detected.

8. The method according to the claim 7, further comprising writing to the additional memory word only through a specific write command different from the standard write command.

9. The method according to claim 7, wherein detecting comprises verifying the value stored in the additional memory word as soon as the tag is sufficiently power fed, and wherein preventing comprises placing the tag in a deactivated state if said value is equal to the deactivation value.

10. The method according to claim 9, wherein verifying comprises verifying the value stored in the additional memory word in response to the receipt of an interrogation message, and wherein preventing comprises preventing reading and/or transmission of the identifier if said value is equal to the deactivation value.

11. The method according to claim 8, wherein writing comprises commanding writing to the additional memory word in response to the specific write command, without possibility of subsequent erasure or overwriting.

12. The method according to claim 8, wherein writing comprises executing the specific write command only after one of either receipt by the tag of a password or mutual authentication.

13. An integrated circuit memory, comprising:
at least one first memory location for storing a data word;
a second memory location for storing a deactivation word; and
a circuit responsive to a request to access the at least one first memory location to retrieve the data word for determining whether the second memory location contains the deactivation word and, if so, then preventing retrieval of the data word from the first memory location.

14. The integrated circuit memory of claim 13 wherein the memory is located within an RFID tag.

15. The integrated circuit memory of claim 14 wherein the data word is an identification value for the RFID tag.

16. The integrated circuit memory of claim 13 wherein the circuit further prevents writing to the second memory location unless a certain write command is used that is different from a write command used to write to the first memory location.

17. The integrated circuit memory of claim 16 wherein the circuit further prevents subsequent erasure or overwriting of the stored deactivation word.

18. A method for integrated circuit memory operation, the memory including at least one first memory location for storing a data word and a second memory location for storing a deactivation word, the method comprising:
responding to a request to access the at least one first memory location to retrieve the data word by determining whether the second memory location contains the deactivation word and, if so, then preventing retrieval of the data word from the first memory location.

19. The method of claim 18 wherein the memory is located within an RFID tag.

20. The method of claim 19 wherein the data word is an identification value for the RFID tag.

21. The method of claim 18 further including preventing writing to the second memory location unless a certain write command is used that is different from a write command used to write to the first memory location.

22. The memory of claim 21 further including preventing subsequent erasure or overwriting of the stored deactivation word.

23. An RFID tag, comprising:
at least one first memory location for storing a data word which identifies the RFID tag;
a second memory location for storing a deactivation word; and
a circuit responsive to a received tag interrogation signal requesting RFID tag identification for determining whether the second memory location contains the deactivation word and, if so, then preventing retrieval of the data word identifying the RFID tag from the first memory location.

24. The tag of claim 23 wherein the circuit further prevents writing to the second memory location unless a certain write command is used that is different from a write command used to write the data word to the first memory location.

25. The tag of claim 24 wherein the circuit further prevents subsequent erasure or overwriting of the stored deactivation word.

26. The tag of claim 23 wherein the circuit verifies that the deactivation word stored in the second memory location matches a certain value.

27. The tag of claim 23 wherein the circuit allows writing to the second memory location only if a password has been received.

28. The tag of claim 23 wherein the circuit allows writing to the second memory location only if a mutual authentication process has been completed between the tag and a remote interrogation unit.

29. A method of RFID tag operation, wherein the tag includes at least one first memory location for storing a data word which identifies the RFID tag and a second memory location for storing a deactivation word, the method comprising:
receiving a tag interrogation signal that requests RFID tag identification;
determining whether the second memory location contains the deactivation word; and
if so, then preventing retrieval of the data word identifying the RFID tag from the first memory location.

30. The method of claim 29 further comprising preventing writing to the second memory location unless a certain write command is used that is different from a write command used to write the data word to the first memory location.

31. The method of claim 30 further comprising preventing subsequent erasure or overwriting of the stored deactivation word.

32. The method of claim 29 wherein determining comprises verifying that the deactivation word stored in the second memory location matches a certain value.

33. The method of claim 29 further comprising allowing writing to the second memory location only if a password has been received.

34. The method of claim 29 further comprising allowing writing to the second memory location only if a mutual authentication process has been completed between the tag and a remote interrogation unit.
